(19) United States
(12) Patent Application Publication
(10) Pub. No.: US 2010/0127667 A1
(43) Pub. Date: May 27, 2010

(54) Charging system for a vehicle

(76) Inventors: Shih-Yao Lin, Sindian City (TW); Fang-Ming Hsieh, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,631

(22) Filed: Feb. 26, 2009

(30) Foreign Application Priority Data
Nov. 26, 2008 (TW) 97221143

(51) Int. Cl. H02J 7/04

(52) U.S. Cl. 320/153; 320/162

(57) ABSTRACT

A charging system for a vehicle includes an EMI protection unit, a power factor correction unit, a DC-to-DC converting unit, a DC-to-DC control unit, and a micro-control unit. The power factor correction unit receives an AC voltage via the EMI protection unit and outputs a stable DC voltage. The DC-to-DC converting unit couples to receive the DC voltage and charge the chargeable battery. The DC-to-DC control unit couples to the DC-to-DC converting unit for controlling the DC-to-DC converting unit to charge the chargeable battery. The micro-control unit couples to the DC-to-DC control unit to execute a first charging process to inform the DC-to-DC control unit for controlling the DC-to-DC converting unit to output a first charge voltage, or to execute a second charging process to inform the DC-to-DC control unit for controlling the DC-to-DC converting unit to output a second charge voltage.

### BACKGROUND OF THE INVENTION

1. Field of the Invention

The present invention relates to a charging system for a vehicle. In particular, the present invention relates to a charging system for the rechargeable battery by outputting voltage stage by stage.

2. Description of Related Art

The usage life of the rechargeable battery is determined by the design of the charging system. The design of the charging system includes whether the charging voltage and the charging current are stable, whether a proper charging voltage and a charging current is provided when the rechargeable battery is full, and the compensation of the temperature during the charging process, etc.

The battery for a vehicle usually is a large-capacity VRLA-CELL, a GEL-CELL, or an AGM-CELL that is a power source for starting the vehicle or a power source for the vehicle electric equipment.

The best charging mode for the rechargeable battery is determined on the type of the rechargeable battery. However, the charging system for a vehicle usually merely provides a kind of charging mode to charge the vehicle battery. If the chargeable battery of the vehicle is changed to another kind of rechargeable battery, the charging system still can charge the new kind of the rechargeable battery. But, it cannot charge the rechargeable battery in the best way so that the usage life of the rechargeable battery is shortened.

Because the large-capacity rechargeable battery is expensive, the cost of the rechargeable battery is a heavy loading for the vehicle owner.

### SUMMARY OF THE INVENTION

One particular aspect of the present invention is to provide a charging system for a vehicle that can charge the rechargeable battery by a first charging way or a second charging way. The charging effect is improved.

The charging system for a vehicle includes an EMI protection unit, a power factor correction unit, a DC-to-DC converting unit, a DC-to-DC control unit, and a micro-control unit. The power factor correction unit is coupled with the EMI protection unit that receives an AC voltage from the EMI protection unit and outputs a stable DC voltage. The DC-to-DC converting unit is coupled with the power factor correction unit and the chargeable battery that receives the DC voltage and charges the chargeable battery. The DC-to-DC control unit is coupled with the DC-to-DC converting unit for controlling the DC-to-DC converting unit to charge the chargeable battery. The micro-control unit is coupled with the DC-to-DC control unit to execute a first charging process to inform the DC-to-DC control unit for controlling the DC-to-DC converting unit to output a first charge voltage, or to execute a second charging process to inform the DC-to-DC control unit for controlling the DC-to-DC converting unit to output a second charge voltage.

The present invention designs two kinds of charging processes according to the best charge format of the rechargeable batteries, and utilizes the micro-control unit to execute these two charging processes. At the same time, the micro-control unit executes one kind of the charging process according to the switch of a selection switch to inform the DC-to-DC converting unit for controlling the DC-to-DC converting unit to output a proper charge voltage to charge the rechargeable battery in a best way.

Therefore, the present invention can solve the problem of the usage life of the rechargeable battery being shortened due to the charging system for a vehicle of the prior art cannot charge the new kind of rechargeable battery in the best way.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a block diagram of the preferred embodiment of the present invention;

FIGS. 2A and 2B are block diagrams of the detail circuit of the present invention;

FIG. 3 is a schematic diagram of the compensation relation between the charge voltage and the temperature of the present invention;

FIG. 4 is a schematic diagram of the first charge procedure of the present invention;

FIG. 5 is a schematic diagram of the second charge procedure of the present invention;

FIG. 6 is another schematic diagram of the second charge procedure of the present invention; and

FIG. 7 is a waveform diagram of the PWM of the fan control of the present invention.

### DETAILED DESCRIPTION OF THE PREFERRED EMBODIMENTS

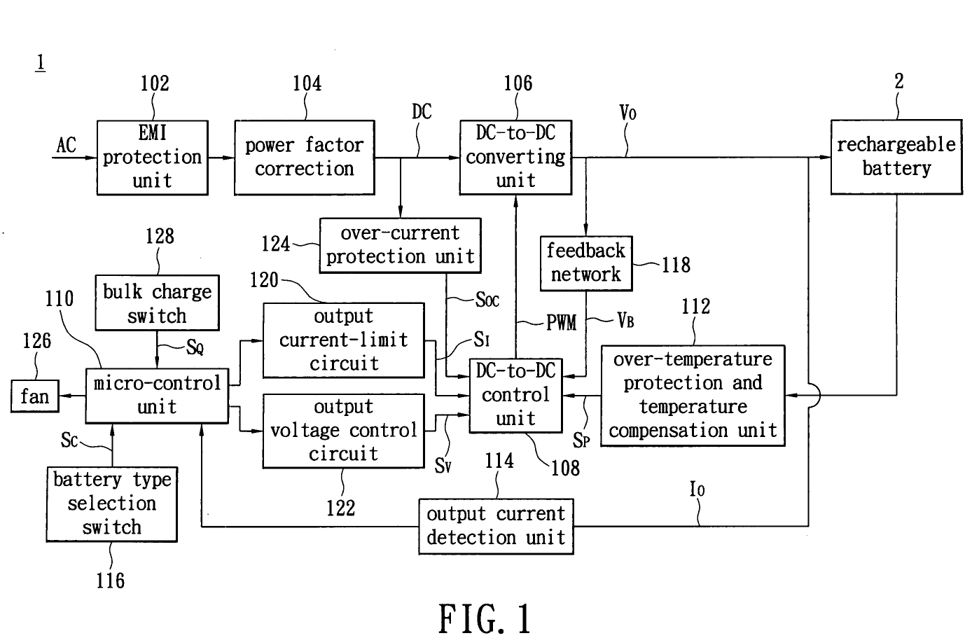

Reference is made to FIG. 1, which shows a block diagram of the preferred embodiment of the present invention. The charging system 1 is used for a vehicle (not shown in the figure) to charge the rechargeable battery 2 on the vehicle. The charging system 1 includes an EMI protection unit 102, a power factor correction unit 104, a DC-to-DC converting unit 106, a DC-to-DC control unit 108, a micro-control unit 11O, a over-temperature protection and temperature compensation unit 112, an output current detection unit 114, a battery type selection switch 116, a feedback network 118, an output current limit circuit 120, an output voltage control circuit 122, an over-current protection unit 124, a fan 126, and a bulk charge switch 128. The rechargeable battery 2 is a GEL-CELL, a VRLA-CELL, or an AGM-CELL.

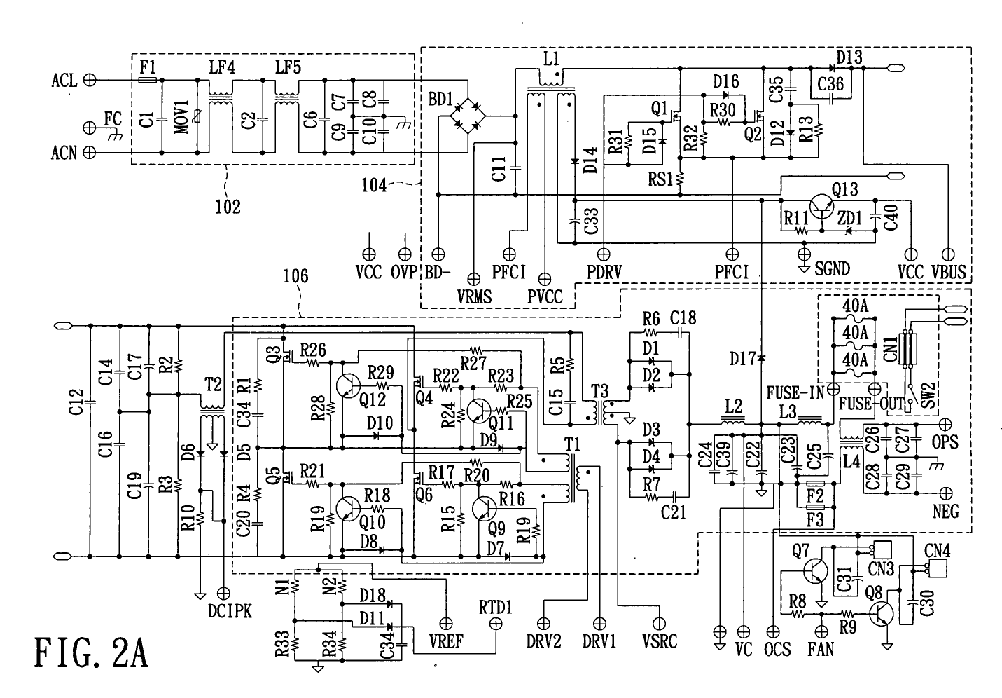

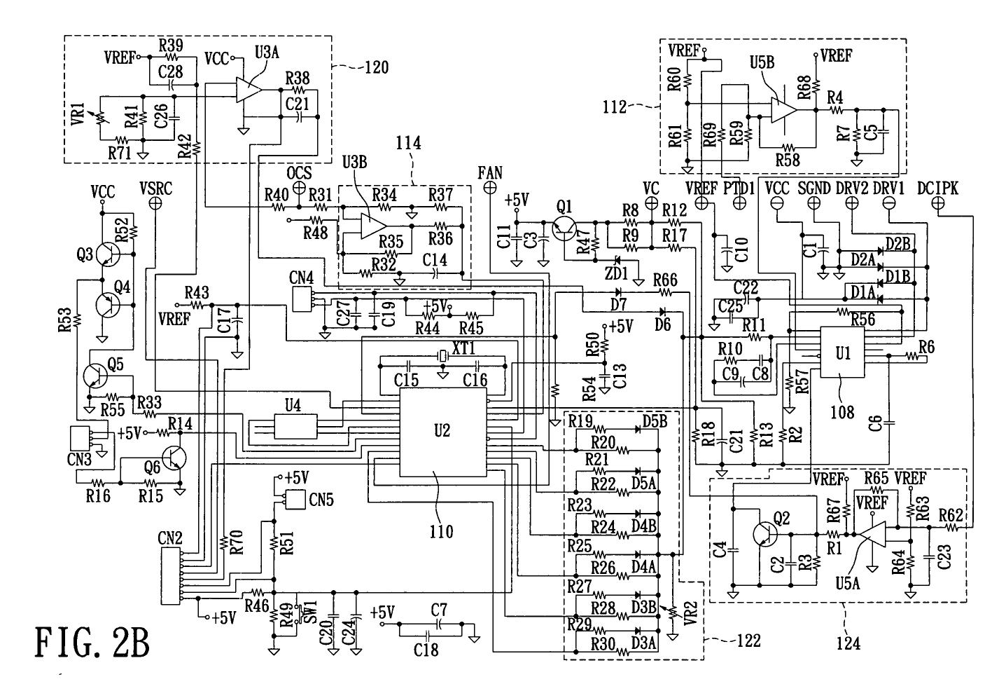

Reference is made to FIG. 1 again. In the charging system 1, the EMI protection unit 102 is used for preventing the high frequency EMI generated from the charging system 1 for interfering with other electronic elements, and is a filtering circuit composed of inductors and capacitors. As shown in FIG. 2, it is the detail circuit of the present invention. The EMI protection unit 102 is composed of elements C1, LF4, C2, LF5, C6, C7, C8, C9, and C10.

The power factor correction unit 104 is coupled with the EMI protection unit 102 for receiving an AC voltage AC from the EMI protection unit 102 and outputs a stable DC voltage DC. The output DC voltage DC of the power factor correction unit 104 is set to 380 Vdc. That means no matter the AC voltage AC is 110 Vac or 220 Vac, the output DC voltage DC of the power factor correction unit 104 is 380 Vdc. Alternatively, the output DC voltage DC of the power factor correction unit 104 is set to 200 Vdc that is used for the AC voltage AC is 110 Vac. As shown in FIG. 2, the power factor correction unit 104 is composed of elements BD1, L1, Q1, Q2, and D13.

Reference is made to FIG. 1 again. The DC-to-DC converting unit 106 is coupled with the power factor correction unit 104 and the chargeable battery 2 for receiving the DC voltage and charging the chargeable battery 2. As shown in FIG. 2A, the DC-to-DC converting unit 106 is a half-bridge structure, and is composed of elements Q3, Q4, Q5, Q6, T3, D1, D3, L2, L3. The DC-to-DC control unit 108 is coupled with the DC-to-DC converting unit 106 to output a driving signal PWM for controlling the DC-to-DC converting unit 106 to charge the chargeable battery 2.

As shown in FIG. 2B, it is a detailed circuit of the present invention. In this embodiment, the DC-to-DC control unit 108 is a SG3525A control chip U1 that its working frequency is 25 KHz and its dead-time is 1 μs. The DC-to-DC control unit 108 obtains an output voltage signal VB from the output terminal of the DC-to-DC converting unit 106 via the feedback network 118 to adjust the duty cycle of the output driving signal PWM according to the output voltage signal VB to stabilize the output voltage Vo of the DC-to-DC converting unit 106.

Furthermore, the DC-to-DC control unit 108 obtains an over-current signal Soc from the input terminal of the DC-to-DC converting unit 106 via the over-current protection circuit 124, and protects the DC-to-DC converting unit 106 according to the over-current signal Soc. The over-current protection circuit 124 uses a current transformer (CT) to obtain the input current of the DC-to-DC converting unit 106, and uses a comparator (not shown in the figure) to set the over-current protection value. Thereby, when the current of the DC-to-DC converting unit 106 is larger than the over-current protection value, the over-current protection circuit 124 generates an over-current signal Soc to control the DC-to-DC control unit 108 to be disable. Therefore, the output driving signal PWM is disabled to stop the DC-to-DC converting unit 106 to prevent the DC-to-DC converting unit 106 from being damaged due to over-current. As shown in FIG. 2B, the over-current protection circuit 124 is composed of elements USA, Q2.

Reference is made to FIG. 1 again. The over-temperature protection and temperature compensation unit 112 installs heat-sense resistors N1, N2 (as shown in FIG. 2A) onto two cooling plates (not labeled) to detect the environment temperature of the cooling plates on the rechargeable battery 2 and output an environment temperature signal SP to the DC-to-DC control unit 108 according to the environment temperature. The DC-to-DC control unit 108 determines whether the rechargeable battery 2 is too heat or not according to the environment temperature signal SP. If the temperature is too high, the DC-to-DC control unit 108 stops operating to prevent the DC-to-DC converting unit 106 from being damaged due to the temperature is too high. As shown in FIG. 2B, the over-temperature protection and temperature compensation unit 112 is composed of an operation amplifier U5B and other resistors.

The DC-to-DC control unit 108 executes the charge voltage temperature compensation mode (cycle use: −5 mV/° C., standby use: −3.3 mV/° C.) according to the environment temperature signal SP. The charge voltage temperature compensation is implemented by a stage mode to divide the environment temperature into four stages. Each stage corresponds to a battery voltage compensation value. Therefore, the charge voltage temperature compensation can reduce the adjusted resolution of the output voltage Vo and the precise of the heat-sense resistor, and divide the environment temperature into four stages to omit the calibration process when the charging system is produced.

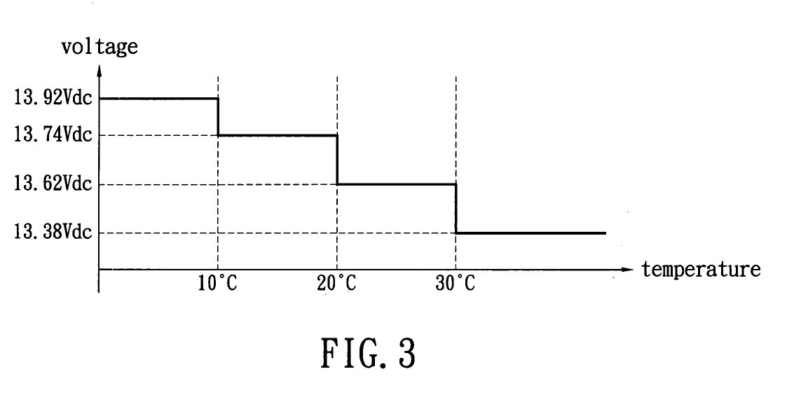

The relation between the output voltage Vo and the temperature compensation is shown in FIG. 3. When the environment temperature is under 10° C., the charge voltage is 13.92 Vdc. When the environment temperature is between 10° C. and 20° C., the charge voltage is 13.74 Vdc. When the environment temperature is between 20° C. and 30° C., the charge voltage is 13.62 Vdc. When the environment temperature is over 30° C., the charge voltage is 13.38 Vdc.

Reference is made to FIG. 1 again. The micro-control unit 110 is coupled with the DC-to-DC control unit 108 via the output current-limit circuit 120 and the output voltage control circuit 122. The micro-control unit 110 executes a first charging process to control the output current-limit circuit 120 to output a current reference signal SI to the DC-to-DC control unit 108, and controls the output voltage control circuit 122 to output a voltage reference signal SV to the DC-to-DC control unit 108 and inform the DC-to-DC control unit 108 for controlling the DC-to-DC converting unit 106 to output a first charge voltage (not labeled). Alternatively, the micro-control unit 110 executes a second charging process to control the output current-limit circuit 120 to output a current reference signal SI and control the output voltage control circuit 122 to output a voltage reference signal SV to inform the DC-to-DC control unit 108 for controlling the DC-to-DC converting unit 106 to output a second charge voltage (not labeled).

Reference is made to FIG. 2B. The output current-limit circuit 120 is composed of the operation amplifier U3A, the resistor R41, the resistor R42, the capacitor C26, the resistor R71, and the adjustable resistor VR1. The operation amplifier U3A is used as a comparison circuit that receives a fixed period PWM signal from the micro-control unit 110, and outputs a DC level current reference signal SI via the RC filter (R38, C21) and the diode D6. The DC level current reference signal SI is outputted to the DC-to-DC control unit 108 to set the reference voltage of the output current comparator (not labeled) in the DC-to-DC control unit 108 to limit the current.

The output voltage control circuit 122 is a D/A converter composed of resistor R19, resistor 20, diode D2B, resistor R29, resistor R30 and diode D3A. The output voltage control circuit 122 is controlled by the micro-control unit 110 to output the voltage reference signal SV to set the reference point of the error amplifier (not labeled) in the DC-to-DC control unit 108 to change the voltage.

Reference is made to FIG. 1 again. The micro-control unit 110 is coupled with the battery type selection switch 116 for receiving a selection signal SC and executing the first charge process or the second charge process according to the selection signal SC. The battery type selection switch 116 is a DIP switch. When the micro-control unit 110 executes the first charge process, the first charge voltage outputted from the DC-to-DC converting unit 106 includes a floating charge voltage and an absorption charge voltage. When the micro-control unit 110 executes the second charge process, the second charge voltage outputted from the DC-to-DC converting unit 106 includes a bulk charge voltage, a floating charge voltage and an absorption charge voltage.

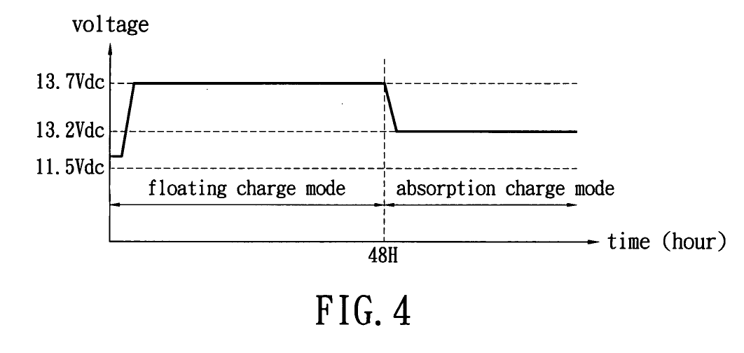

Reference is made to FIGS. 1 and 4. FIG. 4 is a schematic diagram of the first charge procedure of the present invention. When the battery type selection switch 1 16 is switched to “ON”, it means that the rechargeable battery 2 is a GEL-CELL. At this time, the micro-control unit 110 executes the first charge process to provide the first stage charge. The charge voltage (floating charge voltage) is 13.7 Vdc, and the period is 48 hours. The charge voltage of the second stage charge is 13.2 Vdc (absorption charge voltage). When the voltage of the rechargeable battery 2 is under 13.2 Vdc, the process is recovered to the first stage charge.

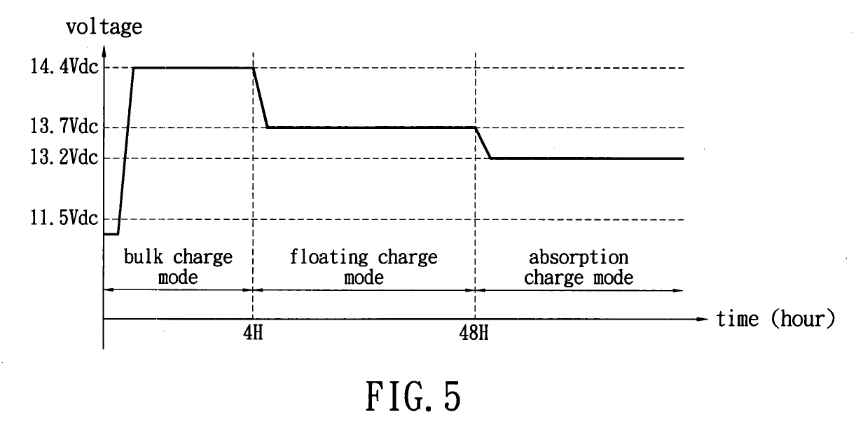

Reference is made to FIGS. 1 and 5. FIG. 5 is a schematic diagram of the second charge procedure of the present invention. When the battery type selection switch 116 is switched to “OFF”, it means that the rechargeable battery 2 is a VRLA-CELL or an AGM-cell. At this time, the micro-control unit 110 executes the second charge process to provide the first stage charge. The charge voltage (bulk charge voltage) is 14.4 Vdc, and the period is 4 hours. After the rechargeable battery 2 is performed with the first stage charge, the second stage charge is executed. The charge voltage is 13.7 Vdc (floating charge voltage) and the period is 44 hours. After the second stage charge is finished, a third stage charge is executed. The charge voltage is 13.2 Vdc (absorption charge voltage).

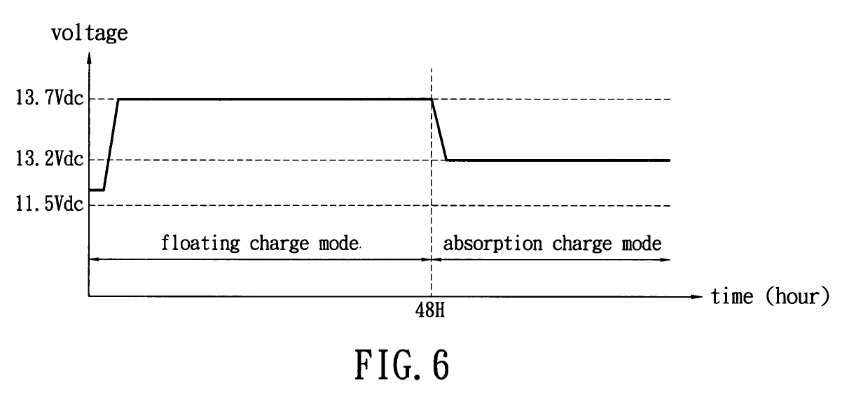

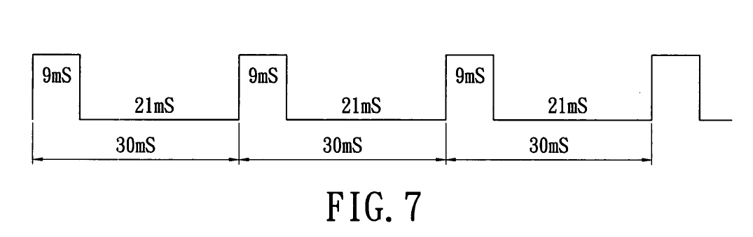

Reference is made to FIGS. 1 and 6. FIG. 6 is another schematic diagram of the second charge procedure of the present invention. The first stage charge is the voltage of the rechargeable battery 2 is 13.2 Vdc. The goal is to start the first stage charge when the rechargeable battery 2 is not used for a long time. Therefore, when the rechargeable battery 2 does not need the first stage charge, the rechargeable battery 2 is performed with the second stage charge. The charge voltage is 13.7 Vdc (floating charge voltage), and the period is 48 hours. After the second stage charge is finished, the third stage charge is executed and the charge voltage is 13.2 Vdc (absorption charge voltage).

Furthermore, when the micro-control unit 110 executes the first charge process or the second charge process, no matter the charge voltages between each stage is from low to high or from high to low, the charge voltages are gradually adjusted, and the period is about 100 ms to prevent the output voltage from being substantially increased or decreased to generate the power noise to damage the elements, such as micro-control unit 110 etc.

Reference is made to FIG. 1 again. The micro-control unit 110 also is coupled with the bulk charge switch 128, receives a bulk charge signal SQ from micro-control unit 110, and informs the DC-to-DC control unit 108 to control the DC-to-DC converting unit 106 to output the bulk charge voltage according to the bulk charge signal. However, when the micro-control unit 110 executes the first charge process according to the selection signal SC, the micro-control unit 110 is not controlled by the bulk charge switch 128 to output the bulk charge signal SQ.

Reference is made to FIG. 1 again. The micro-control unit 110 also is coupled with the fan 126 and the output current detection unit 114. The micro-control unit 110 obtains the output current lo of the DC-to-DC converting unit 106 via the output current detection unit 114, and controls the operation of the fan 126 in several stages according to the output current Io. As shown in FIG. 2B, the output current detection unit 114 is composed of the operation amplifier U3B and other resistors. The output current detection unit 114 detects the output current Io, and reads the output current lo via the A/D converter (not labeled) in the micro-control unit 110 to be an index for controlling the rotation speed of the fan 126.

Reference is made to FIG. 1 again. The micro-control unit 110 divides the output current Io into four stages to control the rotation speed of the fan 126, and is described as below. When the output current Io is under 15% of the rating current, the fan 126 does not rotate so that the noise of the fan 126 is not generated when the loading is low. When the output current Io is between 15% and 25% of the rating current, the fan 126 is rotated at the lowest speed. When the loading is under half loading, the fan 126 is rotated at the lowest noise to lower the shock to the user generated by the fan 126. When the output current Io is between 25% and 50% of the rating current, the rotation speed of the fan 126 is determined by the output current Io. The larger is the output current, the higher is the rotation speed of the fan 126. The smaller is the output current, the lower is the rotation speed of the fan 126. When the output current Io is over 50% of the rating current, the fan 126 is rotated at the full speed.

The charging system for a vehicle of the present invention utilizes the best charge format for the rechargeable batteries to design two kinds of best charge processes, and utilizes the micro-control unit to execute these two kinds of charge processes. Moreover, the micro-control unit executes one of the charge processes according to the selection of the selection switch to inform the DC-to-DC control unit to control the DC-to-DC converting unit to output a proper charge voltage to charge the rechargeable battery in the best mode.

Therefore, the present invention can solve the problem of the usage life of the rechargeable battery being shortened due to the charging system for a vehicle of the prior art cannot charge the new kind of rechargeable battery in the best way.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A charging system for a vehicle, used for charging a rechargeable battery, comprising:
an EMI protection unit;
a power factor correction unit coupled with the EMI protection unit, wherein the power factor correction unit receives an AC voltage from the EMI protection unit and outputs a stable DC voltage;
a DC-to-DC converting unit coupled with the power factor correction unit and the chargeable battery, wherein the DC-to-DC converting unit receives the DC voltage and charges the chargeable battery;
a DC-to-DC control unit coupled with the DC-to-DC converting unit for controlling the DC-to-DC converting unit to charge the chargeable battery; and
a micro-control unit coupled with the DC-to-DC control unit, wherein the micro-control unit executes a first charging process to inform the DC-to-DC control unit for controlling the DC-to-DC converting unit to output a first charge voltage, or to executes a second charging process to inform the DC-to-DC control unit for controlling the DC-to-DC converting unit to output a second charge voltage.

2. The charging system for a vehicle as claimed in claim 1, wherein the first charge voltage includes a floating charge voltage and an absorption charge voltage.

3. The charging system for a vehicle as claimed in claim 1, wherein the second charge voltage includes a bulk charge voltage, a floating charge voltage and an absorption charge voltage.

4. The charging system for a vehicle as claimed in claim 1, wherein the micro-control unit is coupled with a fan and an output current detection unit, and the micro-control unit obtains an output current of the DC-to-DC converting unit via the output current detection unit and controls the operation of the fan in several stages according to the output current.

5. The charging system for a vehicle as claimed in claim 4, further comprising an output current-limit circuit, wherein the output current-limit circuit is coupled with the micro-control unit and the DC-to-DC control unit, and the output current-limit circuit is controlled by the micro-control unit to output a current reference signal to the DC-to-DC control unit.

6. The charging system for a vehicle as claimed in claim 5, further comprising an output voltage control circuit, wherein the output voltage control circuit is coupled with the micro-control unit and the DC-to-DC control unit, and the output voltage control circuit is controlled by the micro-control unit to output a voltage reference signal to the DC-to-DC control unit.

7. The charging system for a vehicle as claimed in claim 6, further comprising a feedback network, wherein the feedback network is coupled between the DC-to-DC converting unit and the DC-to-DC control unit, and the DC-to-DC control unit stabilizes the output of the DC-to-DC converting unit via the feedback network.

8. The charging system for a vehicle as claimed in claim 7, further comprising an over-current protection unit, wherein the over-current protection unit is coupled between the DC-to-DC converting unit and the DC-to-DC control unit to output an over-current signal to the DC-to-DC control unit to provide the over-current protection.

9. The charging system for a vehicle as claimed in claim 8, further comprising an over-temperature protection and temperature compensation unit, wherein the over-temperature protection and temperature compensation unit is coupled with the rechargeable battery and the DC-to-DC control unit, and the over-temperature protection and temperature compensation unit detects an environmental temperature and outputs an environmental temperature signal to the DC-to-DC control unit according to the environmental temperature.

10. The charging system for a vehicle as claimed in claim 8, further comprising a bulk charge switch, wherein the bulk charge switch is coupled with the micro-control unit and outputs a bulk charge signal to the micro-control unit, and the micro-control unit informs the DC-to-DC control unit to control the DC-to-DC converting unit to output the bulk charge voltage according to the bulk charge signal.

11. The charging system for a vehicle as claimed in claim 1, further comprising an over-current protection unit, further comprising a battery type selection switch, wherein the battery type selection switch is coupled with the micro-control unit, and the battery type selection switch outputs a selection signal to the micro-control unit to control the micro-control unit to execute the first charging process or the second charging process.

12. The charging system for a vehicle as claimed in claim 1, wherein the rechargeable battery is a GEL-CELL, a VRLA-CELL, or an AGM-cell.
